(19) United States
(12) Patent Application Publication
(10) Pub. No.: US 2007/0061895 A1
(43) Pub. Date: Mar. 15, 2007

(54) Product inventory image management system

(75) Inventors: Christopher Gene Ceraolo, Lake Worth, FL (US); James Robert Blocker, Delray Beach, FL (US)

Correspondence Address: GUNSTER, YOAKLEY & STEWART, PA, BROWARD FINANCIAL CENTRE, SUITE 1400, 500 EAST BROWARD BLVD, FT LAUDERDALE, FL, 33394, US

(73) Assignee: Photowalk Productions, LLC

(21) Appl. No.: 11/226,559

(22) Filed: Sep. 14, 2005

(51) Int. Cl. H04L 9/32

(52) U.S. Cl. 726/28

(57) ABSTRACT

A method of managing product images comprising the steps of establishing an inventory of products, obtaining a plurality of digital images of the inventory of products, storing the plurality of digital images of the inventory of products, providing a set of rules for controlling access to the plurality of digital images of the inventory of products, providing a management system for implementing the set of rules to control access to the plurality of digital images of the inventory of products based on the set of permissions granted to an authorized user, receiving an access request from a remote user via a network, determining whether the user is an authorized user who is authorized to access the plurality of digital images of the inventory of products, determining the set of permissions granted to the authorized user, and allowing the authorized user to access the plurality of digital images of the inventory of products via a network according to the set of permissions granted to the authorized user.

### CROSS-REFERENCE TO RELATED APPLICATION

N/A

### STATEMENT REGARDING FEDERALLY SPONSORED RESEARCH OR DEVELOPMENT

N/A

### BACKGROUND OF THE INVENTION

Prior art merchandising companies, e.g., office supply companies, offer a myriad of products. Providing hardcopy product catalogs, online catalogs, and advertising materials has been an expensive and relatively uncontrolled process resulting in a nonuniform presentation of products and duplication of efforts and expenses. Accordingly, there has been a long felt need for a process that provides company employees with the ability to use their creative talents to choose images of the products for specific advertising purposes without duplicating costs and efforts while maintaining a consistent product image.

### SUMMARY OF THE INVENTION

In accordance with the present invention there is provided a method of managing product images comprising the steps of establishing an inventory of products, obtaining a plurality of digital images of the inventory of products, storing the plurality of digital images of the inventory of products, providing a set of rules for controlling access to the plurality of digital images of the inventory of products, providing a management system for implementing the set of rules to control access to the plurality of digital images of the inventory of products based on the set of permissions granted to an authorized user, receiving an access request from a remote user via a network, determining whether the user is an authorized user who is authorized to access the plurality of digital images of the inventory of products, determining the set of permissions granted to the authorized user, and allowing the authorized user to access the plurality of digital images of the inventory of products via a network according to the set of permissions granted to the authorized user.

The present invention also provides a method of managing product images comprising the steps of establishing an inventory of products, obtaining a plurality of digital images of the inventory of products, storing the plurality of digital images of the inventory of products, providing a set of rules for controlling access to the plurality of digital images of the inventory of products and for approving the use of a digital image of a product for particular purpose, providing a management system for implementing the set of rules to control access to the plurality of digital images of the inventory of products based on the set of permissions granted to an authorized user, receiving an access request from a remote user via a network, determining whether the user is an authorized user who is authorized to access the plurality of digital images of the inventory of products, determining the set of permissions granted to the authorized user, allowing the authorized user to access the plurality of digital images of the inventory of products via a network according to the set of permissions granted to the authorized user, and allowing an authorized user to review the digital images of a product and to select a digital image for a particular purpose.

Still further, the present invention provides a method of creating an image database for an inventory of products comprising the steps of establishing an inventory of products, obtaining a plurality of digital images of the inventory of products at different angles from a plane through the center of the respective product, and storing the plurality of digital images of the inventory of products.

The present invention ensures quality control over the images of the product inventory resulting in dependable image content, latest product version, and a streamlined approval process that is paperless. Accessibility to the product images and data files associated with the products is available globally. The product can be searched by part number, category, description, text in comment fields and so forth. All personnel access and use same database of product images and have instant image availability. The method of the present invention provides flexibility in choosing images for different advertising media. Personnel can exhibit creativity by choosing from multiple angles to provide the right product image and can utilize multiple delivery modes to provide downloadable, print-ready images. All departments work with a consistent set of images rather than incurring the expense and inconsistency of having photographs taken by individual departments for advertising purposes. The approval process for selection of an image for a special use is done without physical documents and is available for use by an authorized user anywhere in the world. The methods of producing up to 360-degree renderings of products provides personnel with the necessary views to properly advertise any type of product.

Other advantages and applications of the present invention will be made apparent by the following detailed description of the preferred embodiment of the invention.

### BRIEF DESCRIPTION OF THE SEVERAL VIEWS OF THE DRAWINGS

FIG. 1 is a block diagram illustrating one embodiment of the present invention.

FIG. 2 is a flowchart illustrating one embodiment of the present invention.

FIG. 3 is a flowchart illustrating one embodiment of the present invention.

FIG. 4 is a diagram illustrating how a user interacts with a product image.

FIG. 5 is a diagram illustrating one embodiment of a graphical user interface of the present invention.

FIG. 6 is a flowchart illustrating one embodiment of the present invention.

FIG. 7 is an example of a mechanical drawing utilized with the present invention.

FIG. 8 is a flowchart illustrating one embodiment of the present invention.

FIG. 9 is a diagram illustrating one embodiment for generating product images.

FIG. 10 is a flowchart illustrating one embodiment of the present invention.

### DETAILED DESCRIPTION OF THE INVENTION

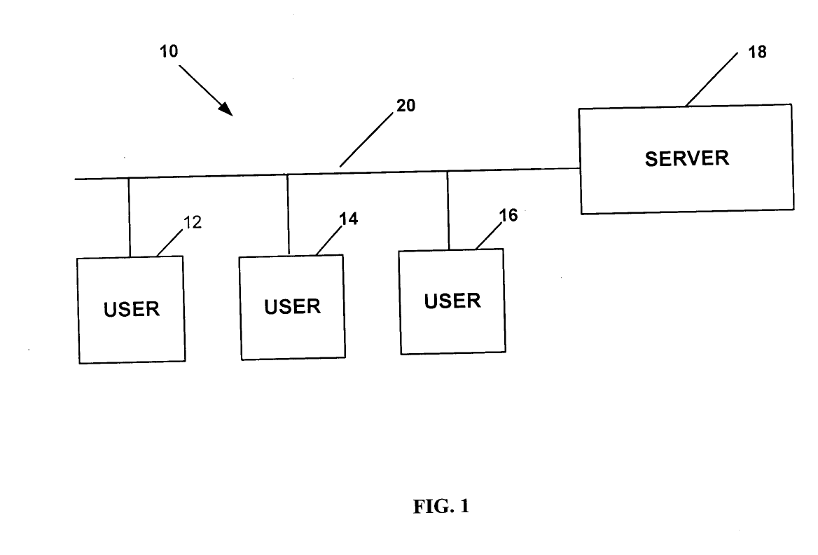

Referring to FIG. 1, the system 10 comprises a plurality of user computers 12, 14, and 16 connected to server 18 via communication network 20. Network 20 can be, for example, a local area network (LAN) or wide area network (WAN), such as the Internet. User computers 12, 14, and 16 can be workstation computers with a monitor or laptop computers. Server 18 stores and implements a number of programs and files, such as a system control program, product inventory database, product images database, rules and permissions program and database, and product approval database. The product inventory database can contain a data file associated with the images of product. This data file can contain, for example, information about the product, SKU, price, and so forth.

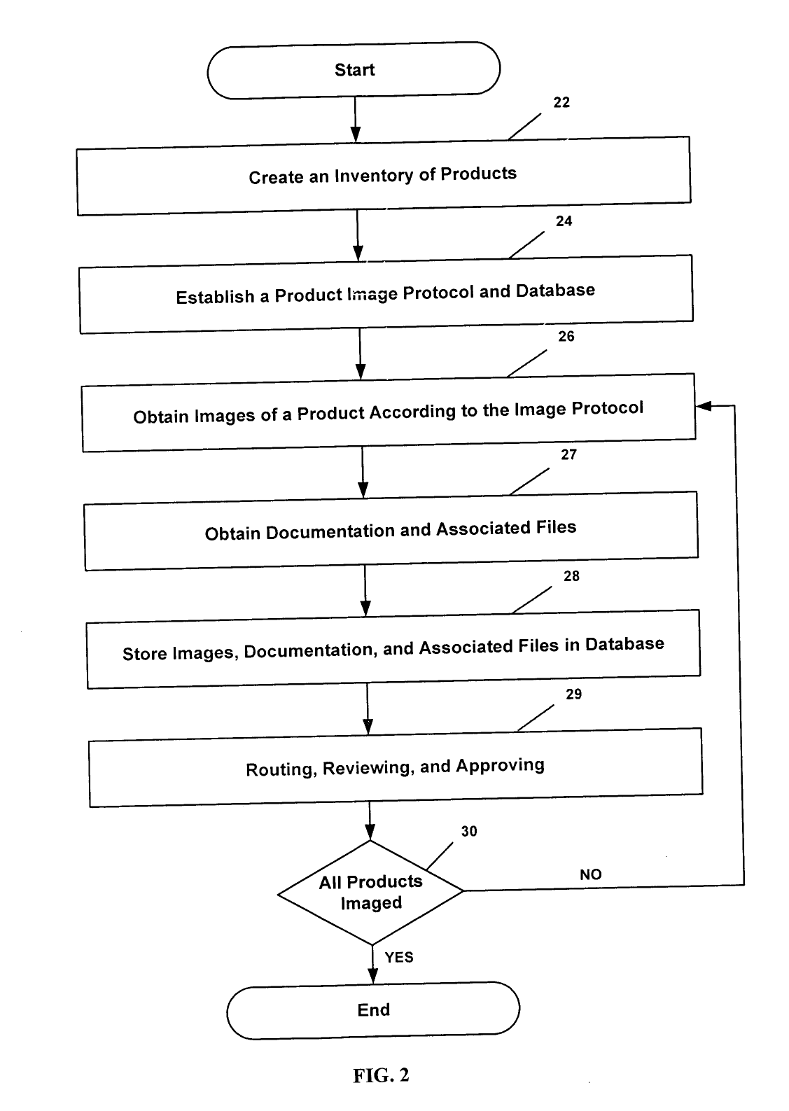

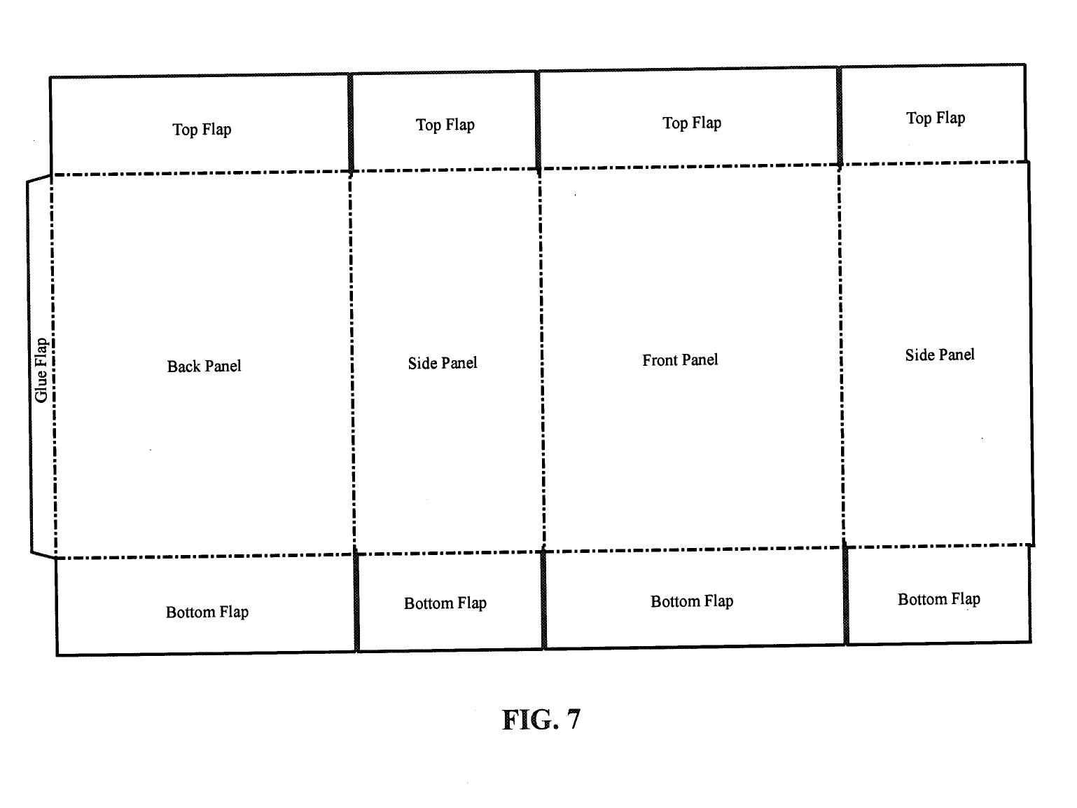

A flowchart of an overall system process is illustrated in FIG. 2. At step 22 an inventory of products is created and stored in the product inventory database in server 18. A product image protocol and database is established at step 24. The product image protocol includes such criteria as the image resolution, number of images, angles at which the images are created and so forth. The images of a product are obtained according to the product image protocol in step 26. Product documentation and associated files are obtained in step 27. The documentation and associated files can include product description, supporting documentation, product packaging, product manual, management approval records for this product, copies of marketing and advertising materials, and so forth. The product images, associated files and documentation are stored in the product database in step 28. At step 29, the routing, reviewing, and approving is conducted to obtain appropriate management review and approval. Although not shown in the FIG. 2, any disapproval by management may require reworking of the disapproved materials. Creation of the product images is discussed in detail with reference to FIGS. 7-10. At decision point 30, the issue of whether all products in the inventory of products have been imaged is considered. If all products have been imaged, then the process is complete. Otherwise, the process returns to step 26 to obtain images of the next product in the product inventory. The process of FIG. 2 is repeated when new products are added to the inventory of products.

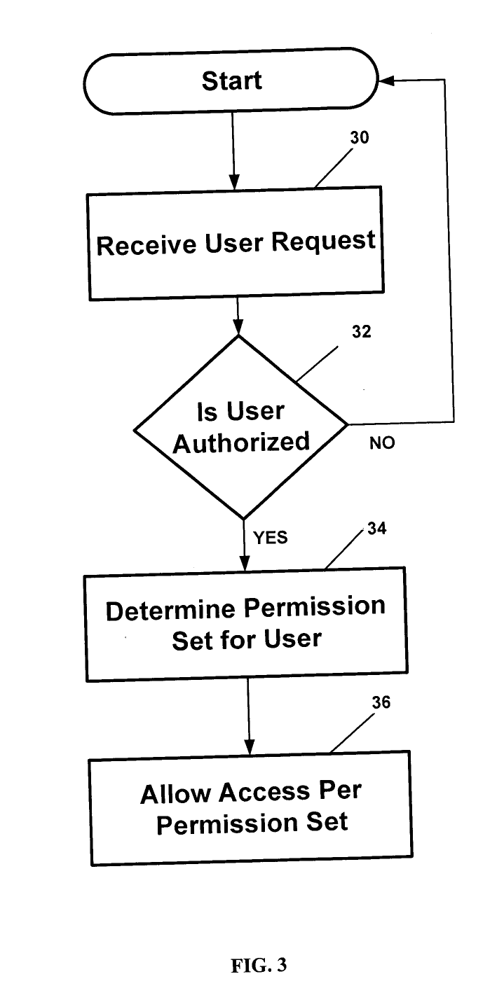

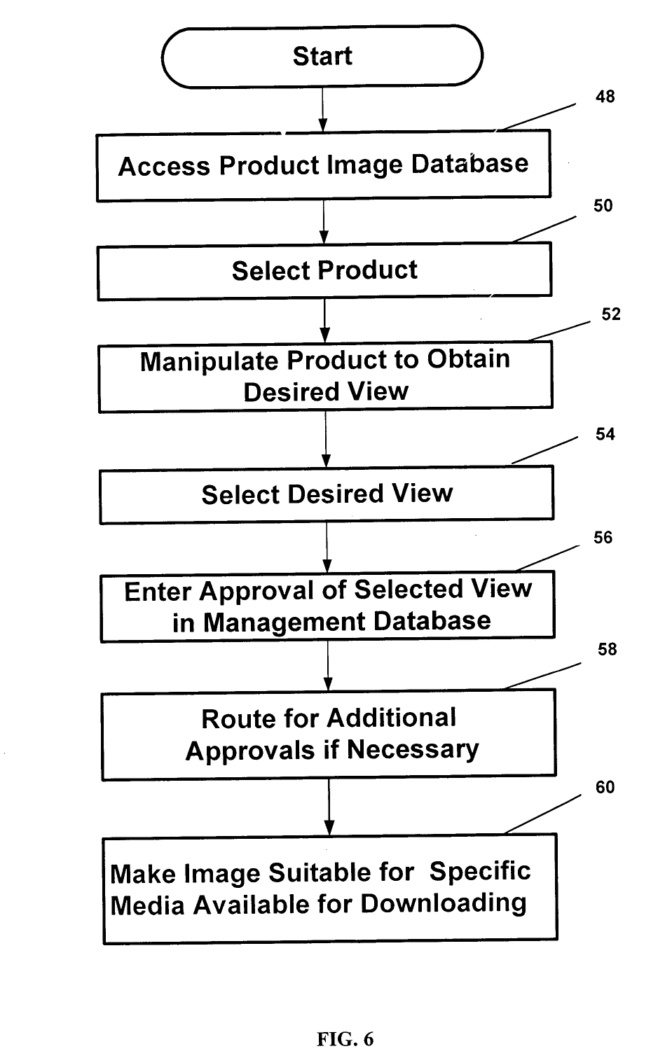

System 10 allows a user to log in from a remote site and access images of the products in the inventory of products database. FIG. 3 illustrates one embodiment of a log in and user approval process according to the present invention. At step 30, server 18 receives a request from a user to access a database of the system. At decision point 32, server 18 determines whether the user is authorized to access the databases. If the user is not authorized, the server denies the requested access. If the user is authorized, then at step 34 the server determines the permission set for this particular user. The permission set for each authorized user is set up by a system administrator. This permission set can include, for example, authority to view all or only certain products, authority to approve the selection of product images for a particular advertising purpose and so forth as illustrated in FIG. 6

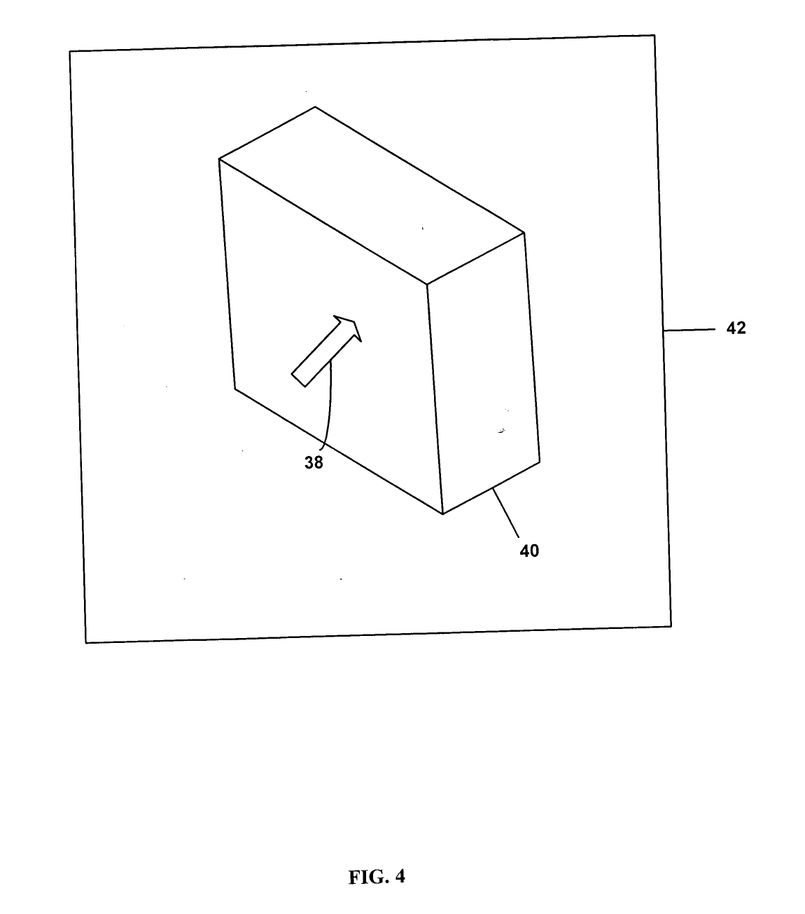

At step 36, server 18 allows an authorized user to access the product images, product documentation, and associated files. The database is searchable so that an authorized user can search products by part number, category, description, text in comment fields, and so forth, per his permission set. Using a standards compliant web browser that supports HTML, the user can manipulate the product image on the screen to view the product from different angles or perspectives without installing any additional software on his computer. As is illustrated in FIG. 4, the user can place the mouse pointer 38 on the product image 40 displayed on the monitor 42 and rotate the product in a desired direction.

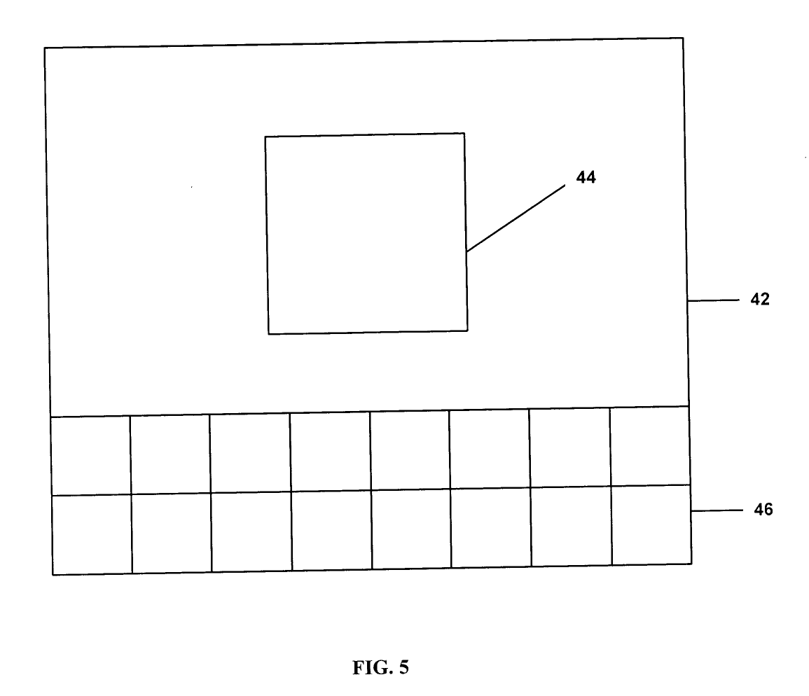

Server 18 can be programmed to automatically download the plurality of images of the product in the product image database so that as the user moves mouse pointer 38, product image 40 changes accordingly so that the product appears to be manipulated as if the user were rotating an actual product in his hand. Alternatively as shown in FIG. 5, server 18 can be programmed to automatically download a primary image 44 and a number of thumbnail images 46 of the chosen product from different angles and orientations and display them on monitor 42. The user can then select any of thumbnail images 46 for viewing. In another embodiment, the downloaded thumbnail images 46 can contain images suitable for different media, such as color, grayscale, a subtractive color model used in color printing such as CMYK, run of press (ROP) colors, high resolution images for virtual catalogs or other digital media. This embodiment allows the user to easily view the product in different media from a single screen.

After a user has logged in and been approved as an authorized user according to the method illustrated in FIG. 3, the user, if authorized to approve the selection of product images for a particular advertising purpose, follows the process illustrated in FIG. 6. At step 48 the authorized user accesses the product image database and then selects a product at step 50. In step 52, the user manipulates the product image and then selects the desired view in step 54. The user by means of his mouse or keyboard enters the approval of the selected view of the product at step 56. The data entered into the system database can include the selected image, identification of the user selecting the image, and the date and time of approval. If additional approvals are necessary for the particular application, then at step 58 server 18 routes the necessary approval to other management via network 20. When all of the necessary approvals have been obtained server 18 allows the downloading of the product image in the suitable format for the specific media, such as for a catalog, newspaper advertisement, or mailing flyer, at step 60. The downloaded product image is a high resolution image and can be in different formats such as color, grayscale, a subtractive color model used in color printing such as CMYK, run of press (ROP) colors, high resolution images for virtual catalogs or other digital media and so forth. The system also ensures that only the latest approved images are available for viewing and downloading. Prior images can be tracked and stored by appropriate personnel, but in general are not available to the normal authorized user.

The plurality of images of the products stored in server 18 can be generated in different ways. A first method of generating product images utilizes mechanical drawing computer files, such as the one shown in FIG. 7 for printing a box for the actual product. This mechanical drawing shows all sides of the box for the actual product. The edges of the box are shown in dotted lines, and the heavy lines on the top and bottom flaps indicate the cut lines. In some applications, a data file associated with the mechanical will provide the dimensions for the box. In other applications the dimensions of the box are measured on the mechanical drawing. These dimensions are then used to create a three-dimensional virtual model in server 18 or other workstation computer. The mechanical drawing computer file illustrates the outside appearance of the product packaging, which can be applied to the exterior of a three-dimensional wire frame model as a skin to create a three-dimensional virtual product that appears like an actual packaged product. The virtual model of the product is then rotated to desired positions and the images of the product in those positions are stored. This process can be performed by graphics personnel using the server or a separate workstation. If a separate workstation is employed then the saved images of the product are uploaded to the server.

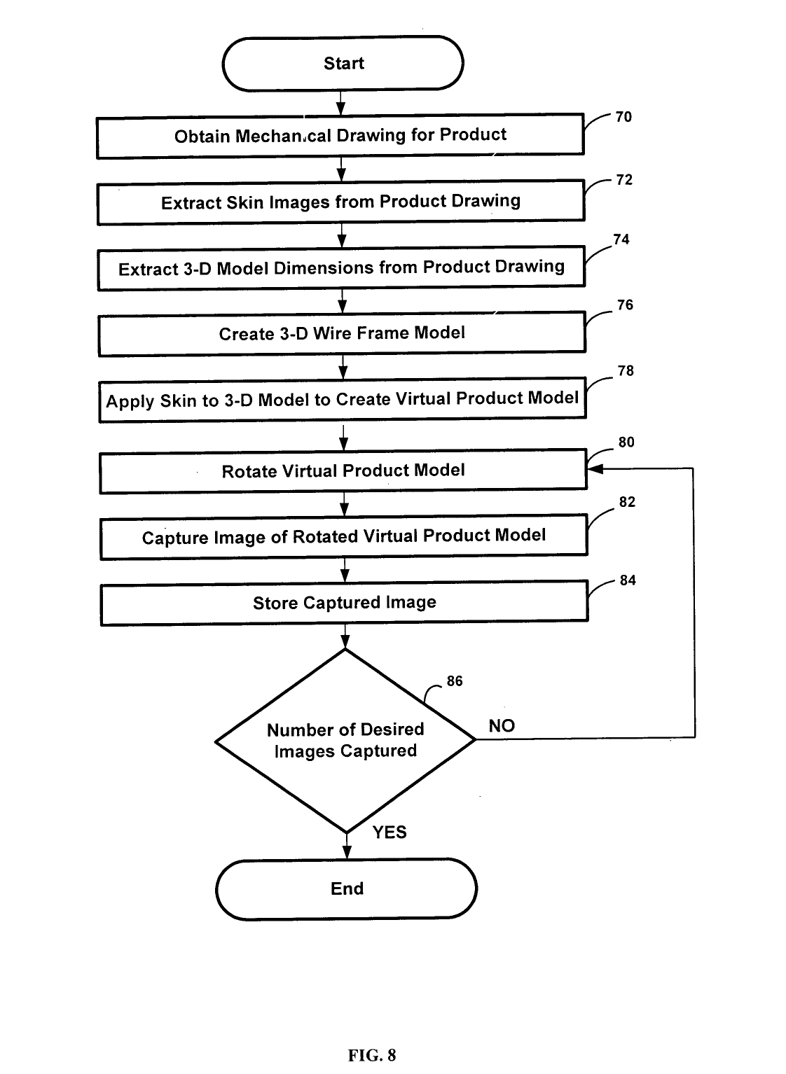

FIG. 8 illustrates a flowchart for implementing the image generation process. At step 70, a digital version of a mechanical drawing of the product is obtained. The skin images and model dimensions are then extracted by graphics personnel from the mechanical drawing in steps 72 and 74 respectively using a vector graphics program. The graphics personnel create a three-dimensional wire frame model in step 76 by entering the model dimensions into a program to create a three-dimensional specification or wire frame model. For example, a box has three dimensions: length, width, and height. The graphics personnel then apply the skin to the three-dimensional wire frame model in step 78 using a vector graphics program to create a virtual product model. The graphics personnel then rotate the virtual product model to desired positions, for example ten degree increments, in step 80, capture the image of the virtual product model in step 82 and then store it in a server, such as server 18 in FIG. 1, in step 84. At decision point 86, the graphics personnel determine if the desired number of images of the virtual product model have been captured. For example, as discussed above, rotating the virtual product model in ten-degree increments would result in 36 images in one plane. If the product is then tilted forward in five increments, this would result in five additional sets of 36 images for a total of 216 images. However, it should be understood that this is merely a business management design decision in determining how many different images should be available to the business personnel. This decision will depend on the nature of the product, for example, where the product is marketed in a box versus one that is not marketed in box. Other factors to be considered are costs and the desired appearance of the line of products in the inventory.

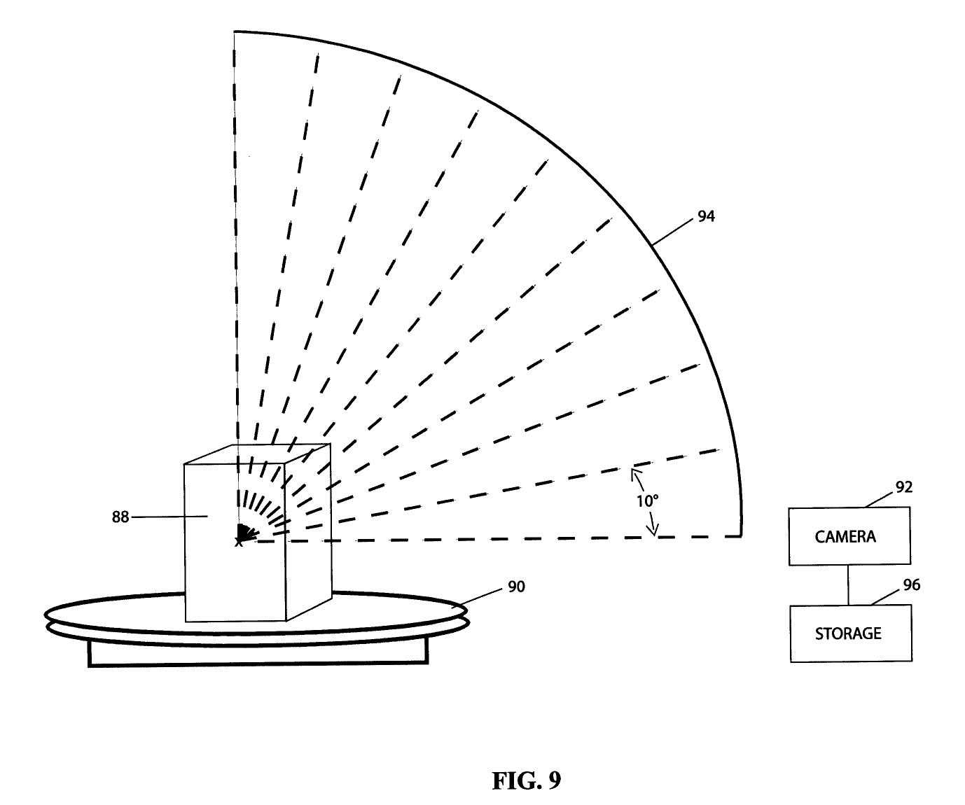

Another method of generating the plurality of images for the products in the inventory of products is illustrated in FIG. 9. A product 88 is positioned on a rotatable turntable 90. An image generator, such as camera 92 is positioned along arc 94, at predetermined positions. A jig or other suitable apparatus can be used to position camera 92 at the desired positions along arc 94. The predetermined positions can be any number of degrees apart; the dotted lines in FIG. 9 illustrate one embodiment in which the positions are ten degrees apart. The dotted lines radiate from the approximate center of product 88. Since turntable 90 is rotatable in one plane, product 88 can be rotated a predetermined number of degrees in the horizontal plane. An image is then generated by camera 92 and provided to storage 96 for temporary storage. Turntable 90 would then be rotated again, and another image is generated by camera 92. This process is repeated until all of the desired images have been taken in this plane. The position of camera 92 along arc 94 is changed to a different position so that the images will be generated from the perspective of a second plane. This process can then be repeated for the desired number of planes. At a later point the images can be uploaded from storage 96 to the system server, such as server 18 in FIG. 1. A single camera 92 is shown in FIG. 9; however, two or more cameras can be located at predetermined points along arc 94. In addition, two or more cameras can be located around product 88 in the first plane where camera 92 is located in FIG. 9 to minimize the number of times that product 88 has to be rotated.

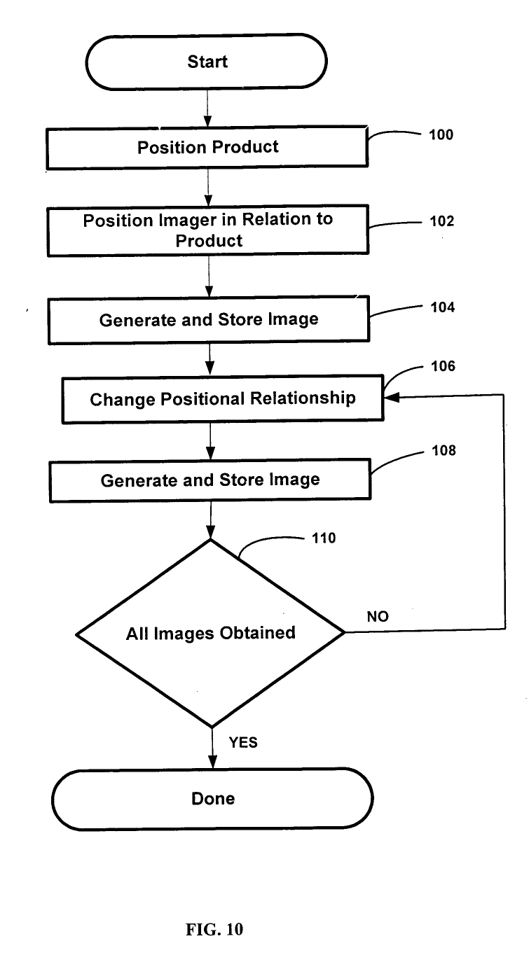

A flowchart of the imaging process is illustrated in FIG. 10. At step 100, product 88 is positioned on turntable 90. Camera 92 is then positioned along arc 94 in relation to product 88 in step 102. At step 104, the image of product 88 is generated by camera 92 and stored in storage 96. The positional relationship between camera 92 and product 88 is then changed in step 106, and another image of product 88 is generated and stored in step 108. At decision point 1 10 the determination is made as to whether all of the desired images have been obtained. If not, the process returns to step 106.

The images can be generated, for example, by consecutively changing the position of the product or the image generator in relation to the product by a set number of degrees. Either the product can be rotated or the camera can be moved around the product. It has been found that a change of ten degrees provides a reasonably pleasing visual effect of fluid rotation of the product, while limiting the number of images required to thirty-six in one plane. Although any number of planes can be used, it has been found that as a practical matter only four or five steps of ten degrees up from the horizontal plane provides satisfactory images for advertising. The result is that the product image viewed on the screen gives the user a choice of images from looking directly at the product in the same plane to tilting the product, and, of course, the option of rotating the product to see, for example, the front and right-hand side. When the product is tilted, then, for example, the image displays the front, right-hand side, and top.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the foregoing disclosure.

What is claimed is:

1. A method of managing product images comprising the steps of: establishing an inventory of products; obtaining a plurality of digital images of the inventory of products; storing the plurality of digital images of the inventory of products; providing a set of rules for controlling access to the plurality of digital images of the inventory of products; providing a management system for implementing the set of rules to control access to the plurality of digital images of the inventory of products based on the set of permissions granted to an authorized user; receiving an access request from a remote user via a network; determining whether the user is an authorized user who is authorized to access the plurality of digital images of the inventory of products; determining the set of permissions granted to the authorized user; and allowing the authorized user to access the plurality of digital images of the inventory of products via a network according to the set of permissions granted to the authorized user.

2. A method as recited in claim 1 wherein said step of obtaining a plurality of digital images of the inventory of products comprises obtaining a plurality of images for each product.

3. A method as recited in claim 2 wherein said step of obtaining a plurality of digital images of the inventory of products comprises obtaining a plurality of images of a product at different angles from a plane through center of the respective product.

4. A method as recited in claim 1 wherein said step of allowing the authorized user to access the plurality of digital images of the inventory of products via a network according to the set of permissions granted to the authorized user comprises allowing the authorized user to view the plurality of digital images of the inventory products at the authorized user's remote computer without installing additional software to the authorized user's remote computer.

5. A method as recited in claim 1 wherein said step of allowing the authorized user to access the plurality of digital images of the inventory of products via a network according to the set of permissions granted to the authorized user comprises downloading all of the digital images of a respective product when the authorized user requests one of the digital images of the respective product.

6. A method as recited in claim 1 wherein said step of allowing the authorized user to access the plurality of digital images of the inventory of products via a network according to the set of permissions granted to the authorized user comprises downloading a set of predetermined thumbnail digital images of a respective product when an authorized user requests a digital image of the respective product.

7. A method as recited in claim I wherein said step of allowing the authorized user to access the plurality of digital images of the inventory of products via a network according to the set of permissions granted to the authorized user comprises allowing the authorized user to access the plurality of digital images of the inventory of products via a network.

8. A method as recited in claim 1 further comprising the step of storing a data file associated with the inventory of products; and wherein said step of providing a set of rules for controlling access further comprises controlling access to the data file associated with the inventory of products, said step of providing a management system for implementing the set of rules to control access further comprises controlling access to the data file associated with the inventory of products based on the set of permissions granted to an authorized user, said step of determining whether the user is authorized to access further comprises determining whether the user is authorized to access the data associated with the inventory of products, and said step of providing access to the user further comprises providing access to the user to the data associated with the inventory of products.

9. A method of managing product images comprising the steps of: establishing an inventory of products; obtaining a plurality of digital images of the inventory of products; storing the plurality of digital images of the inventory of products; providing a set of rules for controlling access to the plurality of digital images of the inventory of products and for approving the use of a digital image of a product for particular purpose; providing a management system for implementing the set of rules to control access to the plurality of digital images of the inventory of products based on the set of permissions granted to an authorized user; receiving an access request from a remote user via a network; determining whether the user is an authorized user who is authorized to access the plurality of digital images of the inventory of products; determining the set of permissions granted to the authorized user; allowing the authorized user to access the plurality of digital images of the inventory of products via a network according to the set of permissions granted to the authorized user; and allowing an authorized user to review the digital images of a product and to select a digital image for a particular purpose.

10. A method as recited in claim 9 wherein said step of allowing an authorized user to review the digital images of a product and to select a digital image for a particular purpose comprises allowing the authorized user to manipulate the image of the product on the authorized users' computer screen so that the authorized user can view the product from different perspectives and to select a digital image for a particular purpose.

11. A method as recited in claim 10 further comprising the step of recording the selection of a digital image for a particular purpose by an authorized user.

12. A method as recited in claim 11 further comprising the step of approving a digital image selected by an authorized user for a particular purpose wherein the approval process is done online without physical documents.

13. A method as recited in claim 12 wherein said step of approving a digital image selected by an authorized user for a particular purpose comprises approving digital images for use in different media.

14. A method as recited in claim 12 wherein said step of approving a digital image selected by an authorized user for a particular purpose comprises the steps of recording the time and date of the approval and the authorized user approving the selection of the digital image.

15. A method as recited in claim 13 further comprising downloading a digital image suitable for use in a particular media.

16. A method of creating an image database for an inventory of products comprising the steps of: establishing an inventory of products; obtaining a plurality of digital images of the inventory of products at different angles from a plane through the center of the respective product; and storing the plurality of digital images of the inventory of products.

17. A method as recited in claim 16 wherein said step of obtaining a plurality of digital images of the inventory of products comprises: receiving a drawing indicative of a respective product; extracting skin images from the drawing; extracting three dimensional model dimensions from the drawing; creating a three dimensional model in computer memory from the three dimensional model dimensions; applying the skin images to the three dimensional model to create a virtual product model; rotating the virtual product model to create images of the virtual product at different angles; and storing the created images of the virtual product.

18. A method as recited in claim 16 wherein said step of obtaining a plurality of digital images of the inventory of products comprises varying the positional relationship between the image generator and the product repeatedly to provide a plurality of digital images at different angles from the plane through the center of the respective product.

19. A method as recited in claim 18 wherein said step of obtaining a plurality of digital images of the inventory of products comprises varying the positional relationship between the image generator and the product repeatedly by a constant angle to provide a plurality of digital images at different angles from the plane through the center of the respective product.

20. A method as recited in claim 16 wherein said step of obtaining a plurality of digital images of the inventory of products comprises varying the positional relationship between the image generator and the product repeatedly by a predetermined angular amount in a first plane; varying the positional relationship between the image generator and the product in a second plane perpendicular to the first plane; and varying the positional relationship between the image generator and the product repeatedly in a third plane parallel to the first plane.

21. A method as recited in claim 16 wherein said step of obtaining a plurality of digital images of the inventory of products comprises using a plurality of image generators to provide a plurality of digital images at different angles from the plane through the center of the respective product.

22. A method as recited in claim 2 wherein said step of obtaining a plurality of digital images of the inventory of products comprises obtaining a plurality of images of a product for use in different media.

23. A method as recited in claim 11 wherein said step of recording the selection of a digital image for a particular purpose by an authorized user comprises the step of storing the date and time of approval and an identification of the authorized user who selected the digital image.

24. A method as recited in claim 8 further comprising the step of allowing an authorized user to search the data associated with the inventory of products.

25. A method as recited in claim 1 further comprising the step of ensuring that only the latest approved version of the plurality of digital images of a product in the inventory of products is accessible by the authorized user.
